(19) United States
(12) Patent Application Publication
(10) Pub. No.: US 2008/0268252 A1
(43) Pub. Date: Oct. 30, 2008

(54) Process for Plasma Coating a Nanocomposite Object

(76) Inventors: Juan Garces, Midland, MI (US); Christopher M. Weikart, Midland, MI (US)

Correspondence Address: The Dow Chemical Company, Intellectual Property Section, P.O. Box 1967, Midland, MI, 48641-1967, US

(21) Appl. No.: 12/064,524

(22) PCT Filed: Sep. 19, 2006
(86) PCT No.: PCT/US06/36496

§ 371 Date: Feb. 22, 2008

Related U.S. Application Data
(60) Provisional application No. 60/718,773, filed on Sep. 20, 2005.

(51) Int. Cl. C08J 7/18; B32B 9/00; B32B 27/32

(52) U.S. Cl. 428/408; 427/491; 427/489; 428/521; 428/451

(57) ABSTRACT

A process for preparing a coating on an object by plasma polymerizing a first compound under conditions to deposit a layer onto the object, the object comprising a nanocomposite polymer. In addition, the object so coated.

### BACKGROUND

Polypropylene, polyethylene and other such polymers have been plasma coated. However, prior art plasma coatings on such polymer surfaces are not as adherent as desired. It would be an advance in the art if a plasma coating process were discovered that produced a more adherent coating on such polymer surfaces.

### SUMMARY OF THE INVENTION

The instant invention is a solution, at least in part, to the above-stated problem. More specifically, the instant invention process for preparing an adherent coating on an object. The process of the instant invention comprises the step of: plasma polymerizing a first compound under conditions to deposit a layer onto the object, the object comprising a nanocomposite polymer such as a polypropylene nanocomposite.

### BRIEF DESCRIPTION OF THE DRAWINGS

FIG. 1 is an illustration of an apparatus used to coat the inside of a nanocomposite container using the method of the instant invention.

### DETAILED DESCRIPTION OF THE INVENTION

Polymeric materials are often coated to improve various properties such as light transmission, anti-reflectance, barrier performance, chemical and scratch resistance. It has been discovered that when the polymer system includes nanocomposites, several benefits result. First, the coating is adherent. In addition, the coating can provide enhanced barrier properties. And, the coating may provide a more receptive surface to receive printing or to otherwise improve or alter the surface energy of the coated article.

Nanometer sized fillers such as nano-tubes, nano-fiber, nano-particles and especially delaminated or exfoliated cation exchanging layered materials (such as delaminated 2:1 layered silicate clays) can be used as a reinforcing filler in a polymer system. Such polymer systems are known as “nanocomposites” when at least one dimension of the filler is less than sixty nanometers and when the amount of such filler is in the range of from 0.1 to 50 weight percent of the nanocomposite. Nanocomposite polymers generally have enhanced mechanical property characteristics vs. conventionally filled polymers. For example, nanocomposite polymers can provide both increased modulus and increased impact toughness, a combination of mechanical properties that is not usually obtained using conventional fillers such as talc. When delaminated or exfoliated cation exchanging layered materials are to be used as the nanometer sized fillers, maleated polymer (such as maleated polypropylene) is often blended into a polymer system to increase the degree of delamination of the cation exchanging layered material. As discussed in detail in EP1268656 (WO 01/48080) an important sub-class of nanocomposite polymers is nanocomposite thermoplastic olefin. Thermoplastic olefin, also termed “TPO” in the art, usually is a blend of a thermoplastic, usually polypropylene, and a thermoplastic elastomer. A nanocomposite TPO is formed when the thermoplastic of the TPO contains the nano-filler.

The cation exchanging layered materials used as the preferred nanometer sized fillers of the invention are often treated with an organic cation (usually an “onium”) to facilitate delamination of the cation exchanging layered material when it is blended with a polymer (see, for example U.S. Pat. No. 5,973,053). Conventionally, the layered material is “fully exchanged”, that is, the exchangeable cations of the layered material are often approximately fully replaced by the onium ions.

The term “cation exchanging layered material” means layered oxides, sulfides and oxyhalides, layered silicates (such as Magadiite and kenyaite) layered 2:1 silicates (such as natural and synthetic smectites, hormites, vermiculites, illites, micas, and chlorites). Examples of cation exchanging layered silicate materials include:

Biophilite, kaolinite, dickalite and talcs;

### Semectites;

### Vermiculites;

### Micas;

Brittle micas;

### Magadiites;

### Kenyaites;

### Octosilicates;

### Kanemites;

### Makatites; and

Zeolitic layered materials (such as ITQ-2, MCM-22 precursor, exfoliated ferrierite and exfoliated mordenite).

The cation exchange capacity of a cation exchanging layered material describes the ability to replace one set of cations (typically inorganic ions such as sodium, calcium or hydrogen) with another set of cations (either inorganic or organic). The cation exchange capacity can be measured by several methods, most of which perform an actual exchange reaction and analyzing the product for the presence of each of the exchanging ions. Thus, the stoichiometry of exchange can be determined. It is observed that the various cation exchanging layered materials have different cation exchange capacities which are attributed to their individual structures and unit cell compositions. It is also observed for some cation exchanging layered materials that not all ions of the exchanging type are replaced with the alternate ions during the exchange procedure.

The term “organic cation” means a cation that contains at least one hydrocarbon radical. Examples of organic cations include, without limitation thereto, phosphonium, arsonium, sulfonium, oxonium, imidazolium, benzimidazolium, imidazolinium, protonated amines, protonated amine oxides, protonated betaines, ammoniums, pyridines, anilines, pyrroles, piperidines, pyrazoles, quinolines, isoqunolines, indoles, oxazoles, benzoxazoles, and quinuclidines. An example of an organic cation is a quaternary ammonium compound (a “quat”) of formula R₁R₂R₃R₄N⁺, wherein at least one of R₁, R₂, R₃ or R₄ contains ten or more carbon atoms. The term “organic cation” also includes treatment of the cation exchanging layered material with an acid followed by treatment with an organic amine to protonate the amine.

The specific base polymer used in the nanocomposite of the instant invention is not critical. However, polymer systems comprising alpha olefin monomers having from two or more carbon atoms are specifically included in the instant invention along with blends of such polymers and copolymers of such monomers (such as copolymers of ethylene and octene) as well as the above-described TPO systems. Polymer systems comprising propylene monomer are highly preferred in the instant invention and are termed “polypropylene” herein and include, without limitation thereto, random copolymer polypropylene, block copolymer polypropylene, homopolymer polypropylene, impact copolymer polypropylene and maleated polypropylene.

The nanocomposites and/or articles made from the nanocomposites are coated with ultra-thin barrier coatings by plasma enhanced chemical vapor deposition. Such coatings may include for example an amorphous carbon layer or a polyorganosiloxane and/or silicon oxide layer. The nanocomposite articles may take the form of many shapes, including pellets and end-use articles such as containers, for example, blow molded bottles. Preferably the coating is applied to the inside surface of the containers.

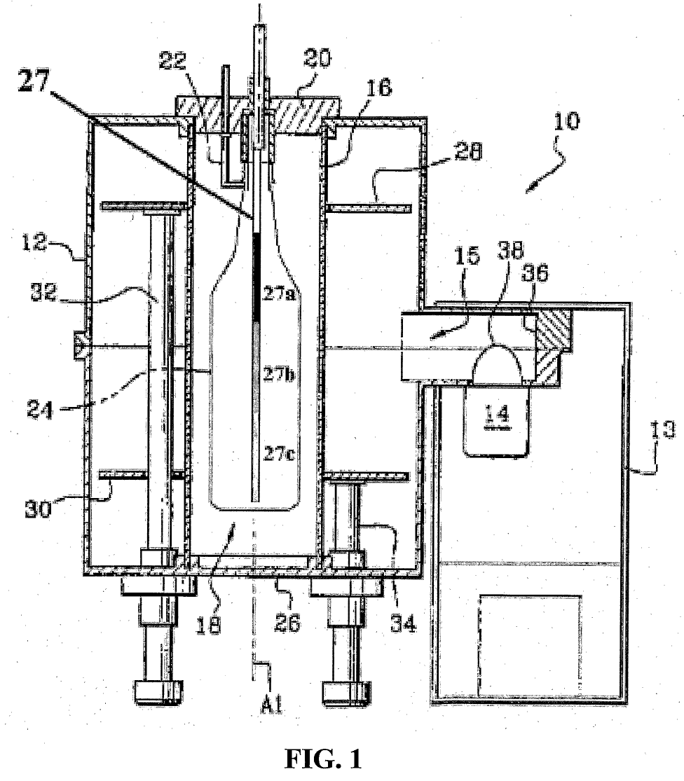

The process of the present invention when used to coat the inside of a container is advantageously, though not uniquely, carried out using the microwave plasma coating apparatus described in WO0066804, which is reproduced with some modification in FIG. 1 and with specific regard to the amorphous carbon, polyorganosiloxane and silicon oxide coating process, the apparatus and method described in United States Patent Application Publication 2004/0149225 A1 (both of which are herein fully incorporated by reference). The apparatus 10 has an external conducting resonant cavity 12, which is preferably cylindrical (also referred to as an external conducting resonant cylinder having a cavity). Apparatus 10 includes a generator 14 that is connected to the outside of resonant cavity 12. The generator 14 is capable of providing an electromagnetic field in the microwave region, more particularly, a field corresponding to a frequency of 2.45 GHz. Generator 14 is mounted on box 13 on the outside of resonant cavity 12 and the electromagnetic radiation it delivers is taken up to resonant cavity 12 by a wave guide 15 that is substantially perpendicular to axis A1 and which extends along the radius of the resonant cavity 12 and emerges through a window located inside the resonant cavity 12. Tube 16 is a hollow cylinder transparent to microwaves located inside resonant cavity 12. Tube 16 is closed on one end by a wall 26 and open on the other end to permit the introduction of a container 24 to be treated by PECVD. Container 24 is a container having at least an inner surface consisting essentially of a nanocomposite polymer.

The open end of tube 16 is then sealed with cover 20 so that a partial vacuum can be pulled on the space defined by tube 16 to create a reduced partial pressure on the inside of container 24. The container 24 is held in place at the neck by a holder 22 for container 24. Partial vacuum is advantageously applied to both the inside and the outside of container 24 to prevent container 24 from being subjected to too large a pressure differential, which could result in deformation of container 24. The partial vacuums of the inside and outside of the container are different, and the partial vacuum maintained on the outside of the container is set so as not to allow plasma formation onto the outside of container 24 where deposition is undesired. Preferably, a partial vacuum in the range of from 20 μbar to 200 μbar is maintained for the inside of container 24 and a partial vacuum of from 20 mbar to 100 mbar, or less than 10 μbar, is pulled on the outside of the container 24.

Cover 20 is adapted with an injector 27 that is fitted into container 24 so as to extend at least partially into container 27 to allow introduction of reactive fluid that contains a reactive monomer and a carrier. Injector 27 can be designed to be, for example, porous, open-ended, longitudinally reciprocating, rotating, coaxial, and combinations thereof. As used herein, the word “porous” is used in the traditional sense to mean containing pores, and also broadly refers to all gas transmission pathways, which may include one or more slits. A preferred embodiment of injector 27 is an open-ended porous injector, more preferably an open-ended injector with graded—that is, with different grades or degrees of—porosity, which injector extends preferably to almost the entire length of the container. The pore size of injector 27 preferably increases toward the base of container 24 so as to optimize flux uniformity of activated precursor gases on the inner surface of container 24. FIG. 1 illustrates this difference in porosity by different degrees of shading, which represent that the top third of the injector 27a has a lower porosity than the middle third of the injector 27b, which has a lower porosity than the bottom third of the injector 27c. The porosity of injector 27 generally ranges on the order of 0.5 μm to 1 mm. However, the gradation can take a variety of forms from stepwise, as illustrated, to truly continuous. The cross-sectional diameter of injector 27 can vary from just less than the inner diameter of the narrowest portion of container 24 (generally from 40 mm) to 1 mm.

The apparatus 10 also includes at least one electrically conductive plate in the resonant cavity to tune the geometry of the resonant cavity to control the distribution of plasma in the interior of container 24. More preferably, though not essentially, as illustrated in FIG. 1, the apparatus 10 includes two annular conductive plates 28 and 30, which are located in resonant cavity 12 and encircle tube 16. Plates 28 and 30 are displaced from each other so that they are axially attached on both sides of the tube 16 through which the wave guide 15 empties into resonant cavity 12. Plates 28 and 30 are designed to adjust the electromagnetic field to ignite and sustain plasma during deposition. The position of plates 28 and 30 can be adjusted by sliding rods 32 and 34.

Deposition of polyorganosiloxane and SiOx layers on the container 24 can be accomplished as follows as described in United States Patent Application Publication 2004/0149225 A1. A mixture of gases including a balance gas and a working gas (together, the total gas mixture) is flowed through injector 27 at such a concentration and power density, and for such a time to create coatings with desired gas barrier properties.

As used herein, the term “working gas” refers to a reactive substance, which may or may not be gaseous at standard temperature and pressure, that is capable of polymerizing to form a coating onto the substrate. Examples of suitable working gases include organosilicon compounds such as silanes, siloxanes, and silazanes. Examples of silanes include tetramethylsilane, trimethylsilane, dimethylsilane, methylsilane, dimethoxydimethylsilane, methyltrimethoxysilane, tetramethoxysilane, methyltriethoxysilane, diethoxydimethylsilane, methyltriethoxysilane, triethoxyvinylsilane, tetraethoxysilane (also known as tetraethylorthosilicate or TEOS), dimethoxymethylphenylsilane, phenyltrimethoxysilane, 3-glycidoxypropyltrimethoxysilane, glycidoxypropyltrimethoxysilane, 3-methacrylpropyltrimethoxysilane, diethoxymethylphenylsilane, tris(2-methoxyethoxy)vinylsilane, phenyltriethoxysilane, and dimethoxydiphenylsilane. Examples of siloxanes include tetramethyldisiloxane, hexamethyldisiloxane, and octamethyltrisiloxane. Examples of silazanes include hexamethylsilazanes and tetramethylsilazanes. Siloxanes are preferred working gases, with tetramethyldisiloxane (TMDSO) being especially preferred. Acetylene working gas is preferably used for the deposition of an amorphous carbon layer.

As used herein, the term “balance gas” is a reactive or non-reactive gas that carries the working gas through the electrode and ultimately to the substrate. Examples of suitable balance gases include air, O₂, CO₂, NO, N₂O as well as combinations thereof. Oxygen (O₂) is a preferred balance gas.

When it is desired to coat the nanocomposite article with a polyorganosiloxane layer, a first organosilicon compound is plasma polymerized in an oxygen rich atmosphere on the inner surface of the container, which may or may not be previously subjected to surface modification, for example, by roughening, crosslinking, or surface oxidation. As used herein, the term “oxygen-rich atmosphere” means that the balance gas contains at least about 20 percent oxygen, more preferably at least about 50 percent oxygen. Thus, for the purposes of this invention, air is a suitable balance gas, but N₂ is not.

The quality of the polyorganosiloxane layer is virtually independent of the mole percent ratio of balance gas to the total gas mixture up to about 80 mole percent of the balance gas, at which point the quality of the layer degrades substantially. The power density of the plasma for the preparation of the polyorganosiloxane layer is preferably greater than 10 MJ/kg, more preferably greater than 20 MJ/kg, and most preferably greater than 30 MJ/kg; and preferably less than 1000 MJ/kg, more preferably less than 500 MJ/kg, and most preferably less than 300 MJ/kg.

In this step, the plasma is sustained for preferably less than 5 seconds, more preferably less than 2 seconds, and most preferably less than 1 second; and preferably greater than 0.1 second, and more preferably greater than 0.2 second to form a polyorganosiloxane coating having a thickness of preferably less than 50 nanometer, more preferably less than 20 nanometer, and most preferably less than 10 nanometer; and preferably greater than 2.5 nanometer, more preferably greater than 5 nanometer (nm).

Preferably such plasma polymerizing step is carried out at a deposition rate of less than about 50 nanometer/sec, more preferably less than 20 nanometer/sec, and preferably greater than 5 nanometer/sec, and more preferably greater than 10 nanometer/sec.

The preferred chemical composition of the polyorganosiloxane layer is SiOxCyHz, where x is in the range of 1.0 to 2.4, y is in the range of 0.2 to 2.4, and z is greater than or equal to 0, more preferably not more than 4.

When it is desired to coat the nanocomposite article (which may or may not have already been coated with a polyorganosiloxane layer) with a silicon oxide layer, a second organosilicon compound, which may be the same as or different from the first organosilicon compound, is plasma polymerized to form a silicon oxide layer on the polyorganosiloxane layer described above, or a different polyorganosiloxane layer or directly on the article. In other words, it is possible, and sometimes advantageous, to have more than one polyorganosiloxane layer of different chemical compositions or no such layer. Preferably, the silicon oxide layer is an SiOx layer, where x is in the range of 1.5 to 2.0.

For such step, the mole ratio of balance gas to the total gas mixture is preferably about stoichiometric with respect to the balance gas and the working gas. For example, where the balance gas is oxygen and the working gas is TMDSO, the preferred mole ratio of balance gas to total gas is 85 percent to 95 percent. The power density of the plasma for the preparation of the silicon oxide layer is preferably greater than 10 MJ/kg, more preferably greater than 20 MJ/kg, and most preferably greater than 30 MJ/kg; and preferably less than 500 MJ/kg, and more preferably less than 300 MJ/kg.

In such plasma polymerizing step, the plasma is sustained for preferably less than 10 seconds, and more preferably less than 5 seconds, and preferably greater than 1 second to form a silicon oxide coating having a thickness of less than 50 nm, more preferably less than 30 nm, and most preferably less than 20 nm, and preferably greater than 5 nm, more preferably greater than 10 nm.

Preferably, such plasma polymerizing step is carried out at a deposition rate of less than about 50 nm/sec, more preferably less than 20 nm/sec, and preferably greater than 5.0 nm/sec, and more preferably greater than 10 nm/sec.

The total thickness of the plasma polymerized layer(s) is preferably less than 100 nm, more preferably less than 50 nm, more preferably less than 40 nm, and most preferably less than 30 nm, and preferably greater than 10 nm. The total plasma polymerizing deposition time (that is, the deposition time for the first and the second layers) is preferably less than 20 seconds, more preferably less than 10 seconds, and most preferably less than 5 seconds.

Coating adhesion is indicated according to the ASTM D-3359 tape test. The adhesion of a coating on a surface is poor when greater than 65 percent of the coating delaminates, which corresponds to a “0” according to the adhesion classification of the tape test. The adhesion of a coating on a surface is excellent when none of the coating delaminates, which corresponds to a “5” according to the adhesion classification of this test.

Barrier performance is indicated by a barrier improvement factor (BIF), which denotes the ratio of the oxygen transmission rate of the uncoated extrusion blow molded polypropylene bottle to the coated bottle. The BIF is measured using an Oxtran 2/20 oxygen transmission device (available from Mocon, Inc.). Measurements were conducted in a controlled room air (that is the test gas) environment at 23° C. and 40 percent relative humidity for at least 24 hour periods. Oxygen transmission rates are expressed in units of cubic centimeters per bottle per day or cc/bottle/day.

The process of the present invention when used to coat a panel or sheet shaped object is advantageously, though not uniquely, carried out using the electrode discharge plasma coating apparatus and procedure described in U.S. Pat. Nos. 5,494,712 and 5,433,786 (both of which are fully incorporated herein by reference). When using such a system, the first and second plasma polymerizing steps are preferably carried out at a power level of from 100 to 1000 KJ/kg and for a time of less than 1 minute (and more preferably for a time less than 30 second, and yet more preferably less than 5 seconds).

W/FM in units of KJ/kg is calculated for the binary mixture of TMDSO and oxygen by the following formula:

$$\frac{W}{{F}_{TMDSO} {M}_{TMDSO} + {F}_{O 2} {M}_{O 2}} \times 1.34 \times {10}^{3}$$

whereby W is power, F is flowrate and M is molecular weight. The molecular weight of TMDSO and oxygen are 134 g/mol and 32 g/mol respectively.

A highly preferred embodiment of the process of the instant invention is the coating of blow molded containers and especially, without limitation thereto, blow molded containers comprising polypropylene. And, a highly preferred embodiment of the object of the instant invention is a coated blow molded container and especially, without limitation thereto, a blow molded container comprising polypropylene. It should be understood that blow molded containers include, without limitation thereto, extrusion blow molded containers and stretch blow molded containers.

### COMPARATIVE EXAMPLE 1

Bottles made of blow-molded polypropylene are plasma coated with amorphous carbon using 160 sccm of acetylene at 350 W for 3 seconds. The polypropylene is an extruder blended formulation of 5 wt percent maleated polypropylene (Polybond 3150 grade from Crompton), about 95 wt percent polypropylene (EP2 S29EB grade, Melt Flow Index of 2, from The Dow Chemical Company) and 0.2 wt percent Irganox B 225 antioxidant from Ciba. The cross-hatch adhesion test indicates an adhesion of 0. The barrier improvement factor test indicates a BIF of about 5.

### COMPARATIVE EXAMPLE 2

Bottles made of blow-molded polypropylene are plasma coated with SiOxCyHz using 10 sccm of TMDSO and 10 sccm of O₂ at 150 W for 0.5 seconds and then with SiOx using 10 sccm of TMDSO and 80 sccm of O₂ at 350 W for 3 seconds. The polypropylene is an extruder blended formulation of 5 wt percent maleated polypropylene from BP, about 95 wt percent polypropylene (EP2 S29B grade from The Dow Chemical Company) and 0.2 wt percent Irganox B 225 antioxidant from Ciba. The cross-hatch adhesion test indicates an adhesion of 0. The barrier improvement factor test indicates a BIF of about 2.

### EXAMPLE 1

Bottles made of blow-molded polypropylene nanocomposite are plasma coated with amorphous carbon using 160 sccm of acetylene at 350 W for 3 seconds. The polypropylene nanocomposite is an extruder blended formulation of 5 wt percent quat treated clay (SOMASIF ME-100 fluoromica from CO-OP Chemical Co., having a quat to clay ion exchange ratio of 1:0.8, the quat being dimethylditallowquaternary amine), 5 wt percent maleated polypropylene from BP, about 90 wt percent polypropylene (EP2 S29B grade from The Dow Chemical Company) and 0.2 wt percent Irganox B 225 antioxidant from Ciba. The cross-hatch adhesion test indicates an adhesion of 5. The barrier improvement factor test indicates a BIF of about 40.

### EXAMPLE 2

Bottles made of blow-molded polypropylene nanocomposite are plasma coated with SiOxCyHz using 10 sccm of TMDSO and 10 sccm of O₂ at 150 W for 0.5 seconds and then with SiOx using 10 sccm of TMDSO and 80 sccm of O₂ at 350 W for 3 seconds. The polypropylene nanocomposite is an extruder blended formulation of 5 wt percent quat treated clay (SOMASIF ME-100 fluoromica from CO-OP Chemical Co., having a quat to clay ion exchange ratio of 1:0.8, the quat being dimethylditallowquaternary amine), 5 wt percent maleated polypropylene from BP, about 90 wt percent polypropylene (EP2 S29B grade from The Dow Chemical Company) and 0.2 wt percent Irganox B 225 antioxidant from Ciba. The cross-hatch adhesion test indicates an adhesion of 5. The barrier improvement factor test indicates a BIF of up to 30.

### CONCLUSION

While this invention has been described as having preferred aspects, the instant invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed is:

1. A process for preparing a coating on an object, comprising the step of: plasma polymerizing a first compound under conditions to deposit a layer onto the object, the object comprising a nanocomposite polymer.

2. The process of claim 1, wherein the nanocomposite polymer comprises polypropylene.

3. The process of any of claims 1 or 2, wherein the layer is an amorphous carbon layer.

4. The process of any of claims 1 or 2, wherein the first compound is a first organosilicon compound and the layer is a polyorganosiloxane layer.

5. The process of any of claims 1 or 2, wherein the first compound is a first organosilicon compound and the layer is a silicon oxide layer.

6. The process of claim 4, further comprising the step of plasma polymerizing a second organosilicon compound, which second organosilicon compound may be the same as or different from the first organosilicon compound, to produce a silicon oxide layer on the polyorganosiloxane layer.

7. An object coated by plasma polymerizing a first compound under conditions to deposit a layer onto the object, the object comprising a nanocomposite polymer.

8. The object of claim 7, wherein the nanocomposite polymer comprises polypropylene.

9. The object of any of claims 7 or 8, wherein the layer is an amorphous carbon layer.

10. The object of any of claims 7 or 8, wherein the first compound is an organosilicon compound and the layer is a polyorganosiloxane layer.

11. The object of any of claims 7 or 8, wherein the first compound is an organosilicon compound and the layer is a silicon oxide layer.

12. The object of claim 10, further comprising a silicon oxide layer on the polyorganosiloxane layer, the silicon oxide layer formed by plasma polymerizing a second organosilicon compound, which second organosilicon compound may be the same as or different from the first organosilicon compound, to produce the silicon oxide layer on the polyorganosiloxane layer.
